(19) United States
(12) Patent Application Publication
(10) Pub. No.: US 2022/0334642 A1
(43) Pub. Date: Oct. 20, 2022

(54) CONTROL DEVICE, CONTROL METHOD, AND NON-TRANSITORY COMPUTER READABLE MEDIUM

(71) Applicant: KABUSHIKI KAISHA TOKAI RIKA DENKI SEISAKUSHO, Aichi (JP)

(72) Inventors: Takeshi OHNISHI, Aichi (JP); Fumiaki HIROSE, Aichi (JP); Yuma NAKAI, Aichi (JP)

(73) Assignee: KABUSHIKI KAISHA TOKAI RIKA DENKI SEISAKUSHO, Aichi (JP)

(21) Appl. No.: 17/640,919

(22) PCT Filed: Apr. 17, 2020
(86) PCT No.: PCT/JP2020/016823

§ 371 Date: Mar. 7, 2022

(30) Foreign Application Priority Data
Sep. 10, 2019 (JP) 2019-164224

(51) Int. Cl. G06F 3/01; G05B 13/02; B06B 1/02

(52) U.S. Cl. CPC G06F 3/016; G05B 13/024; B06B 1/02

(57) ABSTRACT

A control device including a control section configured to vibrate a contact region in a case where it is determined that an operation is performed on an input section by a target object coming into contact with the contact region, the input section having the contact region touched by the target object, wherein the control section adjusts a displacement width as a control parameter for performing control of vibrating the contact region, the displacement width being a difference between a local maximum value of displacement of the contact region caused by the vibration and displacement of the contact region in a criterion state.

### TECHNICAL FIELD

The present invention relates to a control device, a control method, and a program.

### BACKGROUND ART

In recent years, technologies of outputting feedback in response to a user operation have been considered. For example, Patent Literature 1 listed below discloses a technology of giving tactile feedback to a user by vibrating an operation receiver in the case where the user has pressed the operation receiver.

### CITATION LIST

### Patent Literature

Patent Literature 1: JP 2010-287231A

### DISCLOSURE OF INVENTION

### Technical Problem

However, according to the technology disclosed in the above Patent Literature 1, the mere vibration is given as the feedback. Therefore, the feedback has no meaning other than informing the user whether or not the user operation has been accepted.

Accordingly, the present invention is made in view of the aforementioned issues, and an object of the present invention is to provide a mechanism that makes it possible to improve expressiveness of the feedback.

### Solution to Problem

To solve the above described problem, according to an aspect of the present invention, there is provided a control device comprising a control section configured to vibrate a contact region in a case where it is determined that an operation is performed on an input section by a target object coming into contact with the contact region, the input section having the contact region touched by the target object, wherein the control section adjusts a displacement width as a control parameter for performing control of vibrating the contact region, the displacement width being a difference between a local maximum value of displacement of the contact region caused by the vibration and displacement of the contact region in a criterion state.

To solve the above described problem, according to another aspect of the present invention, there is provided a control method comprising vibrating a contact region in a case where it is determined that an operation is performed on an input section by a target object coming into contact with the contact region, the input section having the contact region touched by the target object, wherein the vibration of the contact region includes adjustment of a displacement width as a control parameter for performing control of vibrating the contact region, the displacement width being a difference between a local maximum value of displacement of the contact region caused by the vibration and displacement of the contact region in a criterion state.

To solve the above described problem, according to another aspect of the present invention, there is provided a program that causes a computer to function as a control section configured to vibrate a contact region in a case where it is determined that an operation is performed on an input section by a target object coming into contact with the contact region, the input section having the contact region touched by the target object, wherein the control section adjusts a displacement width as a control parameter for performing control of vibrating the contact region, the displacement width being a difference between a local maximum value of displacement of the contact region caused by the vibration and displacement of the contact region in a criterion state.

### Advantageous Effects of Invention

As described above, according to the present invention, it is possible to provide the mechanism that makes it possible to improve expressiveness of feedback.

### BRIEF DESCRIPTION OF DRAWINGS

FIG. 1 is a diagram illustrating an example of configuration of a system according to an embodiment of the present disclosure.

FIG. 2 is a diagram illustrating an example of relationship between control parameters and sensations created by adjusting the control parameters according to the embodiment.

FIG. 3 is a diagram for describing an example of a control parameter according to the embodiment.

FIG. 4 is a diagram for describing an example of a control parameter according to the embodiment.

FIG. 5 is a flowchart illustrating an example of a flow of a feedback process executed by the system according to the embodiment.

### MODE(S) FOR CARRYING OUT THE INVENTION

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Configuration Example

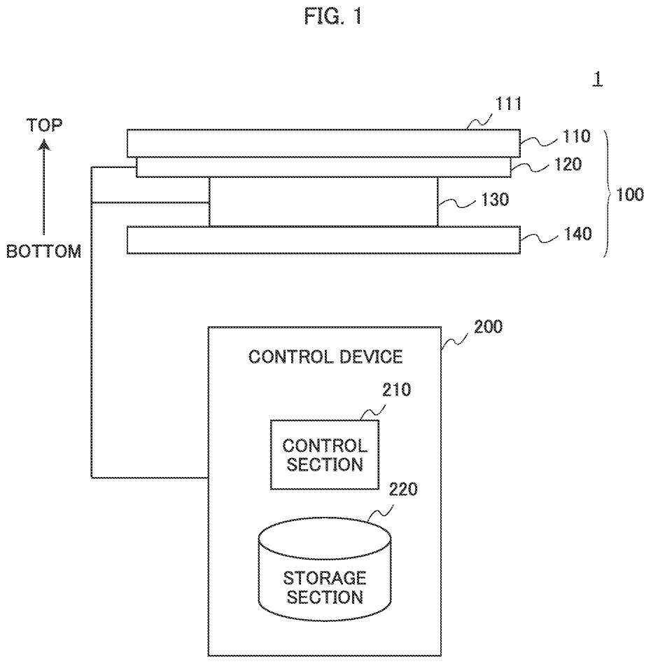

FIG. 1 is a diagram illustrating an example of configuration of a system 1 according to an embodiment of the present disclosure. As illustrated in FIG. 1, the system 1 according to the present embodiment includes an input device 100 and a control device 200. In particular, FIG. 1 illustrates the input device 100 as a cross-sectional view. In addition, FIG. 1 illustrates the control device 200 as a block diagram.

(1) Input Device 100

The input device 100 is a device configured to receive an operation performed by a target object through contact. The target object is any object configured to input information by operating the input device 100. Examples of the target object include a finger of a user, a palm of a hand, various object held in the user's hand, and the like. Examples of the operation performed by a target object through contact include a press operation, which is an operation of pressing a contact region 111 on the operation reception section 110 (to be described later). The input device 100 is an example of an input section according to the present invention.

As illustrated in FIG. 1, the input device 100 includes the operation reception section 110, a detection section 120, an actuator 130, and a supporting material 140. In addition, as illustrated in FIG. 1, the operation reception section 110, the detection section 120, the actuator 130, and the supporting material 140 are provided in this order in one direction. With regard to the one direction, the side of the operation reception section 110 is also referred to as an upper side, and the side of the supporting material 140 is also referred to as a lower side.

The operation reception section 110 is a member configured to receive an operation performed by the target object through contact. The operation reception section 110 has a contact region 111 with which the target object comes into contact. The contact region 111 is a region with which the target object comes into contact.

According to the present embodiment, the operation reception section 110 may be configured as a touchscreen. In this case, the contact region 111 may have any shape such as a rectangular shape, a circular shape, or a rounded-corner box shape when viewed from above. Note that, the operation reception section 110 is not limited to the touchscreen as long as the operation reception section 110 is a member configured to receive the operation performed by the target object through contact. The operation reception section 110 may be configured as various kinds of button, various kinds of knobs, various kinds of levers, or the like as long as it receives the operation.

The detection section 120 is a sensor configured to output an index for detecting the operation performed via the operation reception section 110. For example, the detection section 120 according to the present embodiment may be a pressure-sensitive sensor configured to detect a pressure on the operation reception section 110. In addition, the detection section 120 transmits sensor information to the control device 200. The sensor information indicates the detected pressure.

Note that, the detection section 120 according to the present invention is not limited to the pressure-sensitive sensor. The detection section 120 may be a force sensor configured to detect and output a force applied to the operation reception section 100 or a load sensor configured to detect and output a load applied to the operation reception section 110 as long as the sensor is able to output an index for detecting an operation performed via the operation reception section 110. In addition, the detection section 120 may be a contact point of braking a conductive wire when the operation reception section 110 is operated.

The actuator 130 vibrates under the control of the control device 200. For example, the actuator 130 includes a linear motor actuator, a voice coil motor, and the like.

Here, the operation reception section 110, the detection section 120, and the actuator 130 are connected. Therefore, when the actuator 130 vibrates, the operation reception section 110 also vibrates in conjunction with the actuator 130.

The supporting material 140 is a member that supports structural elements of the input device 100. The supporting material 140 supports the actuator 130.

(2) Control Device 200

The control device 200 is a device configured to control overall operation of the system 1. As illustrated in FIG. 1, the control device 200 includes a control section 210 and a storage section 220.

The storage section 220 has a function of storing various kinds of information for operation performed by the control device 200. For example, the storage section 220 stores various kinds of criterion values of control parameters (to be described later). For example, the storage section 220 includes any storage medium such as flash memory and a read/write device configured to read and write information from and to the storage medium.

The control section 210 controls overall operation of the system 1. For example, the control section 210 is implemented by an electronic circuit such as a central processing unit (CPU), a microprocessing unit (MPU), and an electronic control unit (ECU). For example, the control section 210 vibrates the operation reception section 110 on the basis of sensor information received from the detection section 120. Specifically, the control section 210 determines whether or not an operation has been performed on the operation reception section 110 by the target object coming into contact with the contact region 111, on the basis of the sensor information. For example, the control section 210 determines that the operation has been performed in the case where a pressure detected by the detection section 120 exceeds a predetermined threshold. Alternatively, the control section 210 determines that the operation has not been performed in the case where the pressure detected by the detection section 120 does not exceed the predetermined threshold. Next, the control section 210 vibrates the operation reception section 110 (more specifically, the contact region 111) by vibrating the actuator 130 in the case where it is determined that the operation has been performed on the operation reception section 110 by the target object through contact. This allows the user to receive vibration feedback when operating the operation reception section 110 through contact.

### 2. Technical Features

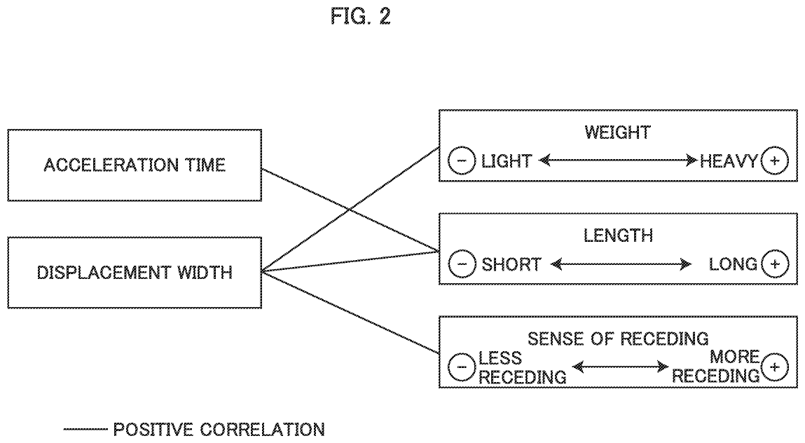

The control section 210 adjusts the control parameters for performing control of vibrating the operation reception section 110. The control parameters are values that define vibration of the operation reception section 110. For example, the parameters that define the vibration include a parameter related to acceleration, a parameter related to displacement, and the like. The control section 210 generates a signal for outputting vibration based on the adjusted control parameters to the actuator 130, and inputs the generated signal to the actuator 130. This allows the actuator 130 and the operation reception section 110 to vibrate on the basis of the adjusted control parameters. In addition, by adjusting the control parameters, it is possible to create various sensations. In other words, appropriate adjustment of the control parameters allows the user to perceive a desired sensation. This makes it possible to improve expressiveness of the feedback. Details of the adjustment of the control parameters and the creation of various sensations will be described with reference to FIG. 2.

FIG. 2 is a diagram illustrating an example of relationship between the control parameters and the sensations created by adjusting the control parameters according to the present embodiment. The control parameters are illustrated in the left side of FIG. 2, and the sensations are illustrated in the right side of FIG. 2. The relationship illustrated in FIG. 2 is revealed by experiments made by the present inventors. The present inventors made the experiments in which, when the control parameters were changed, the user performed the press operation on the input device 100, received feedback, and then answers which sensation the user perceived. In addition, the present inventors carried out a correlation analysis with regard to combinations of the control parameters and the sensations on the basis of results of the experiments on a plurality of users.

In FIG. 2, combinations of control parameters and sensations connected through solid line links each have positive correlation in which a correlation coefficient greater than or equal to a first threshold value is calculated. In other words, when a control parameter changes in a positive direction, a sensation connected to the control parameter through a solid line link also changes in the positive direction. Here, the change in the control parameter in the positive direction means increase in a value of the control parameter. In addition, the change in the sensation in the positive direction means increase in the sensation to be perceived by the user. On the other hand, when a control parameter changes in a negative direction, a sensation connected to the control parameter through a solid line link also changes in the negative direction. Here, the change in the control parameter in the negative direction means decrease in a value of the control parameter. In addition, the change in the sensation in the negative direction means decrease in the sensation to be perceived by the user. Note that, for example, the first threshold may be 0.6.

(1) Created Sensations

As illustrated in FIG. 2, the created sensations include weight, length, and sense of receding. Next, details of the respective sensations will be described.

The “weight” indicates a degree of operation load felt during operation. In the case where the user feels heavy, the operation load felt during the operation is large. In the case where the user feels light, the operation load felt during the operation is small. Here, the change of the weight in the positive direction means that the user perceives heavier load than the sensation before change. The change of the weight in the negative direction means that the user perceives lighter load than the sensation before change.

The “length” indicates a degree of operation displacement felt during operation. In the case where the user feels long, the displacement felt during the operation is large. In the case where the user feels short, the displacement felt during the operation is small. Here, the change of the length in the positive direction means that the user perceives longer displacement than the sensation before change. The change of the length in the negative direction means that the user perceives shorter displacement than the sensation before change.

The “sense of receding” indicates a degree of receding during operation. In the case where the user feels the sense of receding, the degree of receding during operation is high. In the case where the user feels no sense of receding, the degree of receding during operation is low. Here, the change of the sense of receding in the positive direction means that the user perceives a higher degree of receding more than the sensation before change. The change of the sense of receding in the negative direction means that the user perceives a lower degree of receding than the sensation before change.

(2) Adjustment of Control Parameters

Examples of the control parameters to be adjusted include the displacement width. In the present embodiment, acceleration time may be used as the control parameter to be adjusted in addition to the displacement width. Next, details of adjustment of the respective control parameters will be described.

Displacement Width

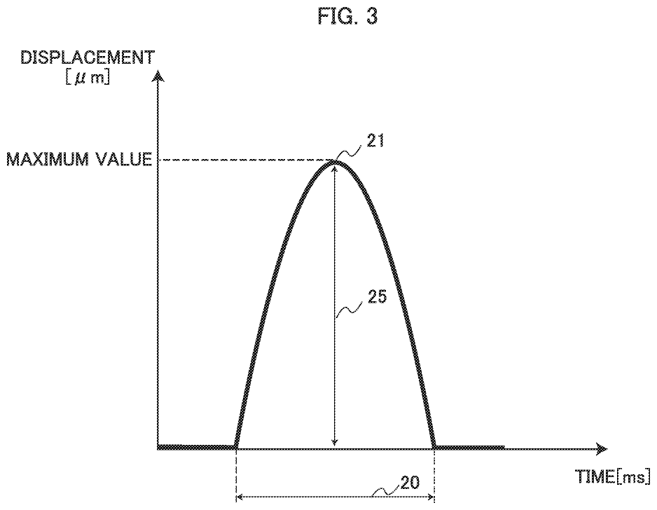

The displacement width is a difference between a local maximum value of displacement of the operation reception section 110 caused by the vibration and displacement of the operation reception section 110 in a criterion state. Here, more specifically, the displacement of the operation reception section 110 is displacement of the contact region 111. In addition, the local maximum value may be a maximum value. For example, the displacement of the operation reception section 110 in the criterion state may be 0 or a local minimum value. Details of the displacement width will be described with reference to FIG. 3.

FIG. 3 is a diagram for describing an example of the control parameter according to the present embodiment. FIG. 3 illustrates a vertical axis representing the displacement of the operation reception section 110 caused by vibration. “Micrometer” is a unit of the displacement. FIG. 3 also illustrates a horizontal axis representing time. The “millisecond” is used as a unit of the time. FIG. 3 illustrates a time period 20, which is a time period where the actuator 130 outputs vibration under the control of the control section 210. Here, for example, one cycle of vibration is output in the time period 20. Even after the time period 20, the displacement may be caused by inertial vibration after the vibration of the actuator 130 is stopped under the control of the control section 210. Here, the displacement width serving as the control parameter may be limited to a displacement width obtained within a time period where the operation reception section 110 outputs vibration under the control of the control section 210. In other words, the displacement width serving as the control parameter does not include a displacement width obtained within a time period where the operation reception section 110 vibrates through inertia. In the example illustrated in FIG. 3, the displacement width 25 is a difference between a maximum value 21 of displacement and a minimum value of the displacement, which is zero, in the time period 20.

The control section 210 adjusts the displacement width. This makes it possible to adjust sensations to be perceived by a user such as the weight, length, and sense of receding as illustrated in FIG. 2. As illustrated in FIG. 2, the displacement width has positive correlation with the weight, length, and sense of receding. Therefore, by adjusting the displacement width toward the positive direction, it is possible to change these sensations in the positive direction. Alternatively, by adjusting the displacement width toward the negative direction, it is possible to change these sensations in the negative direction.

For example, the control section 210 may adjust the displacement width in such a manner that the displacement width exceeds a first criterion value. For example, the first criterion value is a displacement width where vibration of the operation reception section 110 is imperceptible. For example, the first criterion value may be 0. Sharper vibration is obtained as the displacement width increases. Therefore, it is possible for the user to perceive the vibration more easily. In addition, as illustrated in FIG. 2, through the above-described adjustment, it is possible to cause the user to perceive heavier load, longer displacement, and the higher degree of receding than unadjusted vibration. Alternatively, the first criterion value may be a displacement width where vibration of the operation reception section 110 is perceptible. In this case, it is possible for the user to perceive both unadjusted vibration and adjusted vibration. Therefore, it is possible to cause the user to clearly perceive change in sensations caused by the adjustment.

Note that, as the first criterion value, it is also possible to use a displacement width obtained before the adjustment. In this case, it is possible to more flexibly perform control and cause the user to perceive the heavier load, longer displacement, and the higher degree of receding by adjusting the displacement width in such a manner that the displacement width exceeds the first criterion value.

For another example, the control section 210 may adjust the displacement width in such a manner that the displacement width becomes less than a second criterion value. For example, the second criterion value is a displacement width where vibration of the operation reception section 110 is perceptible. For example, the second criterion value may be infinity. Softer vibration is obtained as the displacement width decreases. Therefore, the user becomes less likely to perceive the vibration. In addition, as illustrated in FIG. 2, through the above-described adjustment, it is possible to cause the user to perceive lighter load, shorter displacement, and the lower degree of receding than unadjusted vibration.

Note that, as the second criterion value, it is also possible to use a displacement width obtained before the adjustment. In this case, it is possible to more flexibly perform control and cause the user to perceive the lighter load, shorter displacement, and the lower degree of receding by adjusting the displacement width in such a manner that the displacement width becomes less than the second criterion value.

Acceleration Time

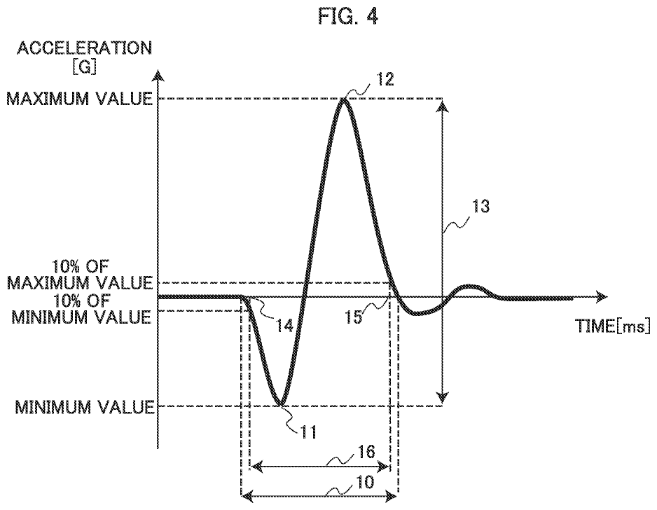

The acceleration time is a time period from time when acceleration applied by vibration to the operation reception section 110 (more specifically, the contact region 111) becomes a first rate value based on a first extreme value of the acceleration for the first time to time when the acceleration becomes a second rate value based on a second extreme value of the acceleration for the last time. Here, the first extreme value may be a local minimum value or a local maximum value. In addition, the second extreme value may also be a local minimum value or a local maximum value. In the case where the first extreme value is the local maximum value, the second extreme value is desirably the local minimum value. On the other hand, in the case where the first extreme value is the local minimum value, the second extreme value is desirably the local maximum value. Note that, the local minimum value may be a minimum value. In addition, the local maximum value may be a maximum value. Details of the acceleration time will be described with reference to FIG. 4.

FIG. 4 is a diagram for describing an example of the control parameter according to the present embodiment. FIG. 4 illustrates a vertical axis representing the acceleration applied by vibration to the operation reception section 110. “G” is used as a unit of the acceleration. FIG. 4 also illustrates a horizontal axis representing time. The “millisecond” is used as a unit of the time. FIG. 4 illustrates a time period 10, which is a time period where the actuator 130 outputs vibration under the control of the control section 210. Here, for example, one cycle of vibration is output in the time period 10. Even after the time period 10, change in the acceleration is change in acceleration of the operation reception section 110 caused by inertial vibration after the vibration of the actuator 130 is stopped under the control of the control section 210.

In the case where acceleration applied for the first time to the operation reception section 110 after the start of vibration is positive acceleration, the acceleration time starts when the acceleration becomes a first rate value for the first time. The first rate value is based on the local maximum value of acceleration (which is an example of the first extreme value). Alternatively, in the case where acceleration applied for the first time to the operation reception section 110 after the start of vibration is negative acceleration, the acceleration time starts when the acceleration becomes a first rate value for the first time. The first rate value is based on the local minimum value of acceleration (which is an example of the first extreme value).

On the other hand, in the case where last acceleration applied to the operation reception section 110 before the end of vibration is positive acceleration, the acceleration time ends when the acceleration becomes a second rate value for the last time. The second rate value is based on the local maximum value of acceleration (which is an example of the second extreme value). Alternatively, in the case where last acceleration applied to the operation reception section 110 before the end of vibration is negative acceleration, the acceleration time ends when the acceleration becomes a second rate value for the last time. The second rate value is based on the local minimum value of acceleration (which is an example of the second extreme value).

Here, the acceleration time serving as the control parameter may be limited to time that falls within a time period where the operation reception section 110 outputs vibration under the control of the control section 210. In other words, the acceleration time serving as the control parameter does not have to include a time period where the operation reception section 110 vibrates through inertia. Note that, each of the first rate and the second rate is any rate of 0% to 100%. In the example illustrated in FIG. 4, the acceleration time 16 is a time period from time 14 when the acceleration becomes 10% of the minimum value of the acceleration for the first time to time 15 when the acceleration becomes 10% of the maximum value of the acceleration for the last time, with regard to one cycle of vibration within the time period 10.

Note that, the first rate and the second rate may be 0%. In this case, the acceleration time is a time period from time when acceleration applied by vibration to the operation reception section 110 becomes zero for the first time to time when the acceleration becomes zero for the last time. In other words, the acceleration time is a time period from start to stop of the vibration.

The control section 210 adjusts the acceleration time. As illustrated in FIG. 2, the acceleration time has positive correlation with the length. Therefore, by adjusting the acceleration time toward the positive direction, it is possible to change this sensation in the positive direction. Alternatively, by adjusting the acceleration time toward the negative direction, it is possible to change this sensation in the negative direction.

For example, the control section 210 may adjust the acceleration time in such a manner that the acceleration time exceeds a third criterion value. For example, the third criterion value is acceleration time in which vibration of the operation reception section 110 is perceptible. For example, the third criterion value may be 0. Softer vibration is obtained as the acceleration time increases. Therefore, the user becomes less likely to perceive the vibration. In addition, as illustrated in FIG. 2, through the above-described adjustment, it is possible to cause the user to perceive longer displacement than unadjusted acceleration time.

Note that, as the third criterion value, it is also possible to use acceleration time obtained before the adjustment. In this case, it is possible to more flexibly perform control and cause the user to perceive the longer displacement by adjusting the acceleration time in such a manner that the acceleration time exceeds the third criterion value.

For another example, the control section 210 may adjust the acceleration time in such a manner that the acceleration time becomes less than a fourth criterion value. For example, the fourth criterion value is acceleration time in which vibration of the operation reception section 110 is imperceptible. For example, the fourth criterion value may be infinity. Sharper vibration is obtained as the acceleration time decreases. Therefore, it is possible for the user to perceive the vibration more easily. In addition, as illustrated in FIG. 2, through the above-described adjustment, it is possible to cause the user to perceive shorter displacement than unadjusted acceleration time. Alternatively, the fourth criterion value may be acceleration time in which vibration of the operation reception section 110 is perceptible. In this case, it is possible for the user to perceive both unadjusted vibration and adjusted vibration. Therefore, it is possible to cause the user to clearly perceive change in sensations caused by the adjustment.

Note that, as the fourth criterion value, it is also possible to use acceleration time obtained before the adjustment. In this case, it is possible to more flexibly perform control and cause the user to perceive the shorter displacement by adjusting the acceleration time in such a manner that the acceleration time becomes less than the fourth criterion value.

(3) Combination of Adjustments of Control Parameters

The control section 210 adjusts the displacement width as a control parameter. In addition, the control section 210 may adjust another control parameter in addition to the displacement width.

For example, the control section 210 may adjust the acceleration time in addition to the displacement width. As illustrated in FIG. 2, displacement width is in common with the acceleration time in that the displacement width and the acceleration time are connected to the length through links. In addition, the direction of the correlation between the displacement width and sensations connected to the displacement width through links and the direction of the correlation between the acceleration time and sensations connected to the acceleration time through links are positive. Therefore, in the case of adjusting both the displacement width and the acceleration time, the control section 210 changes the displacement width and the acceleration time in a same direction (positive or negative direction). This makes it possible to enhance the change in the sensations in the positive direction or the negative direction. The sensations are common to the displacement width and the acceleration time and are connected to the displacement width and the acceleration time through links.

Specifically, the control section 210 adjusts the acceleration time in such a manner that the acceleration time exceeds the third criterion value in the case of adjusting the displacement width in such a manner that the displacement width exceeds the first criterion value. This makes it possible to cause the user to perceive sensations such as sensations of longer displacement more strongly than the case of adjusting the displacement width or the acceleration time alone. On the other hand, the control section 210 adjusts the acceleration time in such a manner that the acceleration time becomes less than the fourth criterion value in the case of adjusting the displacement width in such a manner that the displacement width becomes less than the second criterion value. This makes it possible to cause the user to perceive sensations such as sensations of shorter displacement more strongly than the case of adjusting the displacement width or the acceleration time alone.

(4) Flow of Process

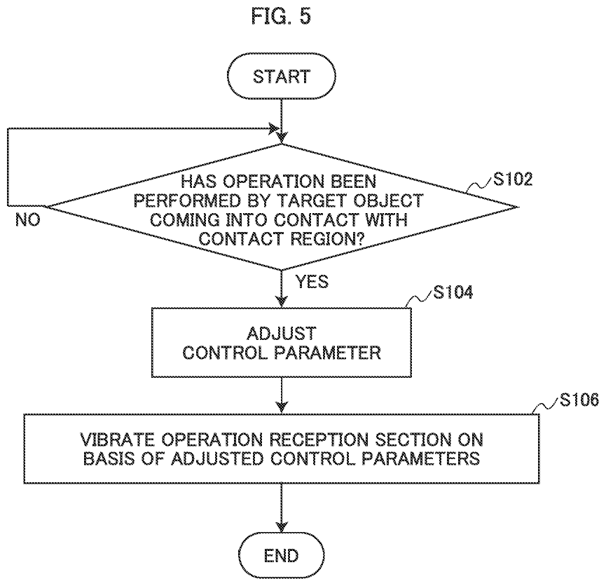

Next, with reference to FIG. 5, a flow of a feedback process according to the present embodiment will be described. FIG. 5 is a flowchart illustrating an example of a flow of a feedback process executed by the system 1 according to the present embodiment.

As illustrated in FIG. 5, the control section 210 first determines whether or not an operation has been performed by the target object coming into contact with the contact region 111 (Step S102). In the case where it is determined that the operation has not been performed (NO in Step S102), the process returns to Step S102. On the other hand, in the case where it is determined that the operation has been performed (YES in Step S102), the process proceeds to Step S104.

In Step S104, the control section 210 adjusts the control parameter. Specifically, the control section 210 adjusts the displacement width. At this time, the control section 210 may adjust the acceleration time in addition to the displacement width. Next, the control section 210 vibrates the operation reception section 110 on the basis of the adjusted control parameters (Step S106). Specifically, the control section 210 generates a signal for outputting vibration based on the adjusted control parameters to the actuator 130, and inputs the generated signal to the actuator 130. This allows the actuator 130 to vibrate on the basis of the adjusted control parameters, and the operation reception section 110 also vibrates on the basis of the adjusted control parameters.

<3. Supplement>

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, the above embodiment has been described on the assumption that the control parameter is a value that defines the vibration of the operation reception section 110. However, the present invention is not limited thereto. For example, as the control parameter, it is possible to adjust a function for outputting the value that defines the vibration of the operation reception section 110.

For example, the above embodiment has been described on the assumption that the operation reception section 110 outputs one cycle of vibration under the control of the control section 210. However, the present invention is not limited thereto. For example, the operation reception section 110 may output a plurality of cycles of vibration under the control of the control section 210.

For example, the above embodiment has been described on the assumption that it is determined whether an operation has been performed on the basis of a pressure detected by the detection section 120. However, the present invention is not limited thereto. For example, the operation reception section 110 may have a function of detecting coordinates of a contact position of the target object in the contact region 111. In this case, it is determined whether an operation has been performed on the basis of whether or not the coordinates of the contact position of the target object has been detected in the contact region 111.

For example, the above embodiment has been described on the assumption that the operation performed by the target object is the press operation. However, the present invention is not limited thereto. For example, the operation reception section 110 may have a function of detecting coordinates of a contact position of the target object in the contact region 111. Next, the operation performed by the target object may be a touch operation performed by the target object coming into contact with the contact region 111, or may be a slide operation performed by the target object moving in the contact region 111 while being in contact with the contact region 111.

Note that, the various kinds of criterion values used for adjusting the control parameters may be fixed or variable. For example, the criterion values may change over time. As an example, a criterion value may be a value of the control parameter decided during last adjustment. In this case, it is possible to cause the user to perceive sensations having different intensity from last adjustment.

Note that, a series of processes performed by the devices described in this specification may be achieved by any of software, hardware, and a combination of software and hardware. A program that configures software is stored in advance in, for example, a recording medium (non-transitory medium) installed inside or outside the devices. In addition, for example, when a computer executes the programs, the programs are read into random access memory (RAM), and executed by a processor such as a CPU. The recording medium may be a magnetic disk, an optical disc, a magneto-optical disc, flash memory, or the like. Alternatively, the above-described computer program may be distributed via a network without using the recording medium, for example.

Further, in the present specification, the processes described using the flowcharts are not necessarily executed in the order illustrated in the drawings. Some processing steps may be executed in parallel. In addition, additional processing steps may be employed and some processing steps may be omitted.

### REFERENCE SIGNS LIST

1 system
100 system
110 operation reception section
120 detection section
130 actuator
140 supporting material
200 control device
210 control section
220 storage section

1. A control device comprising
a control section configured to vibrate a contact region in a case where it is determined that an operation is performed on an input section by a target object coming into contact with the contact region, the input section having the contact region touched by the target object,
wherein the control section adjusts a displacement width as a control parameter for performing control of vibrating the contact region, the displacement width being a difference between a local maximum value of displacement of the contact region caused by the vibration and displacement of the contact region in a criterion state.

2. The control device according to claim 1, wherein
the control section adjusts the displacement width in such a manner that the displacement width exceeds a first criterion value, and
the first criterion value is the displacement width where vibration of the contact region is imperceptible.

3. The control device according to claim 1, wherein
the control section adjusts the displacement width in such a manner that the displacement width becomes less than a second criterion value, and
the second criterion value is the displacement width where vibration of the contact region is perceptible.

4. The control device according to claim 1, wherein
the control section controls the displacement width and acceleration time as the control parameters, and
the acceleration time is a time period from time when acceleration applied by vibration to the contact region becomes a first rate value based on a first extreme value of the acceleration for first time to time when the acceleration becomes a second rate value based on a second extreme value of the acceleration for last time.

5. The control device according to claim 4, wherein
the control section adjusts the acceleration time in such a manner that the acceleration time exceeds a third criterion value in a case of adjusting the displacement width in such a manner that the displacement width exceeds a first criterion value,
the first criterion value is the displacement width where vibration of the contact region is imperceptible, and
the third criterion value is the acceleration time where vibration of the contact region is perceptible.

6. The control device according to claim 4, wherein
the control section adjusts the acceleration time in such a manner that the acceleration time becomes less than a fourth criterion value in a case of adjusting the displacement width in such a manner that the displacement width becomes less than a second criterion value,
the second criterion value is the displacement width where vibration of the contact region is perceptible, and
the fourth criterion value is the acceleration time where vibration of the contact region is imperceptible.

7. A control method comprising
vibrating a contact region in a case where it is determined that an operation is performed on an input section by a target object coming into contact with the contact region, the input section having the contact region touched by the target object,
wherein the vibration of the contact region includes adjustment of a displacement width as a control parameter for performing control of vibrating the contact region, the displacement width being a difference between a local maximum value of displacement of the contact region caused by the vibration and displacement of the contact region in a criterion state.

8. A non-transitory computer readable medium having a program stored therein, the program causing a computer to function as
a control section configured to vibrate a contact region in a case where it is determined that an operation is performed on an input section by a target object coming into contact with the contact region, the input section having the contact region touched by the target object,
wherein the control section adjusts a displacement width as a control parameter for performing control of vibrating the contact region, the displacement width being a difference between a local maximum value of displacement of the contact region caused by the vibration and displacement of the contact region in a criterion state.
